(19) United States
(12) Patent Application Publication
(10) Pub. No.: US 2023/0266514 A1
(43) Pub. Date: Aug. 24, 2023

(54) CURVED LIGHT CONTROLLING STRUCTURES

(71) Applicant: ams Sensors Singapore Pte. Ltd., Singapore (SG)

(72) Inventors: Simon Gubser, Eindhoven (NL); Sonja Gantner, Eindhoven (NL); Nicola Spring, Eindhoven (NL); Sajedeh Manzeli, Eindhoven (NL); Ethouba Aljassin, Eindhoven (NL)

(73) Assignee: ams Sensors Singapore Pte. Ltd., Singapore (SG)

(21) Appl. No.: 18/043,308

(22) PCT Filed: Aug. 3, 2021
(86) PCT No.: PCT/SG2021/050447

§ 371 Date: Feb. 27, 2023

(30) Foreign Application Priority Data
Sep. 3, 2020 (GB) 2013870.7

(51) Int. Cl. G02B 5/24; G02B 5/22; G02B 1/10

(52) U.S. Cl. CPC G02B 5/24; G02B 5/223; G02B 1/10; G02B 2207/123; G09F 9/301

(57) ABSTRACT

A privacy film for a curved display screen. The privacy film has a curved cross section when no force is applied. The privacy film comprises alternating transparent layers and opaque layers, each extending across the privacy film, and each parallel to the other transparent and opaque layers when no force is applied. A method of manufacturing the film is also disclosed.

### FIELD OF THE INVENTION

The present invention relates to privacy films for display screens, and to methods of manufacturing thereof. In particular, the invention relates to privacy films for curved display screens, and their method of manufacture.

### BACKGROUND

Privacy films (also known as “privacy coverings”, “privacy screens” or “privacy filters”) are coverings applied to display screens to limit the viewing angle of the display screen. A typical privacy film is shown in FIGS. 1A and 1B. The privacy film is a flat layer, having a square mesh 102 of opaque elements with transparent sections 101 between the opaque parts.

Viewed in cross section B-B (FIG. 1B), the privacy film appears as a plurality of alternating opaque 102 and transparent 101 sections, with the opaque sections being parallel lines extending across the film. The maximum viewing angle α will depend on the thickness of the layer, and the distance between the opaque elements—i.e. the maximum viewing angle α will be the angle at which the opaque elements physically block the screen, or equivalently the angle connecting the base of one opaque element to the top of the adjacent element. Additionally, opaque elements having a non-rectangular cross section may be used, to further adjust the viewing angle.

With a conventional privacy film, the viewing angle at each point on the screen will be symmetrical about a line perpendicular to the display screen—i.e. a viewer standing at an angle alpha on either side of the screen will be able to see it. While this is generally sufficient for flat display screens, it presents a problem for curved displays. FIG. 2 shows an example of viewing angles when using a conventional privacy film on a curved display 200. A viewer 211 who is directly in front of the screen but at a sufficient distance can see the centre 201 of the display, but is outside the viewing angle for the sides of the display (e.g. the point 202). A viewer 212 who is to one side of the display (i.e. at a point where they are not the intended viewer), cannot see the centre 201 of the display, as intended, but can see content on the curved side opposite them (e.g. the point 202).

In general, due to the curve, a viewer who is beyond the viewing angle of the centre of the curved display may still be able to see content on a part of the curve which is angled towards them. For highly curved screens or very restrictive privacy films, a viewer standing directly in front of the screen may not be able to see all of the content on the screen if they are too far away, due to being outside of the viewing angle of some parts.

### SUMMARY

According to a first aspect of the invention, there is provided a method of manufacturing a privacy film for a curved display screen. A block is provided, comprising alternating transparent layers and opaque layers, wherein the transparent layers and opaque layers are flat. The block is cut to form a film having a curved cross section when no force is applied, with each of the transparent and opaque layers extending across the film. The cut surfaces are polished or a transparent coating is applied to the cut surfaces.

According to a second aspect, there is provided a privacy film for a curved display screen. The privacy film has a curved cross section when no force is applied. The privacy film comprises alternating transparent layers and opaque layers, each extending across the privacy film, and each parallel to the other transparent and opaque layers when no force is applied.

According to a third aspect, there is provided a method of applying a privacy film according to the second aspect to a curved display screen. The display screen has a curved cross section which has a radius of curvature which is less than a radius of curvature of the curved cross section of the privacy film. The method comprises bending the privacy film to reduce its radius of curvature during application of the privacy film.

### BRIEF DESCRIPTION OF THE DRAWINGS

FIGS. 1A and B show a privacy film for a flat display;

FIG. 2 shows exemplary viewing angles when a privacy film such as that depicted in FIGS. 1A and 1B is applied to a curved display;

FIG. 3 shows an exemplary privacy film for a curved display;

FIGS. 4A, 4B, and 4C show the steps of manufacturing a privacy film for a curved display in an example method.

FIG. 5 shows exemplary viewing angles of a curved privacy film on a display screen of a different curvature.

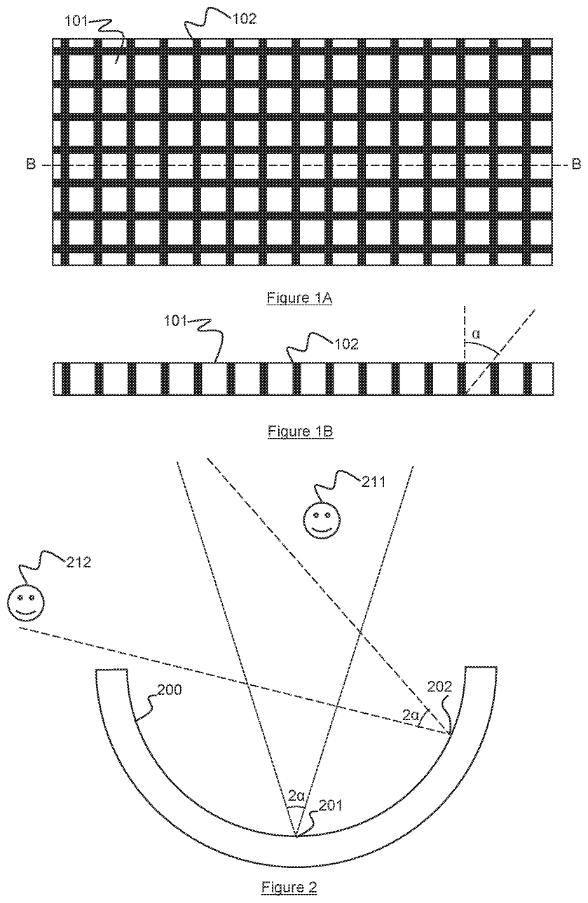

### DETAILED DESCRIPTION

In order to provide a useful privacy film for a curved display, the opaque elements should be parallel when the film is applied to the display—or at least at an angle between where they would be if parallel, and where they would be if a flat privacy film with parallel opaque elements was bent to fit the curved display.

US 2020/0049864 A1 discloses a way of providing this by providing a flat privacy film, with opaque elements set into it at angles such that they are parallel when the film is curved to fit the display. However, this is complex to manufacture, and may be difficult to apply due to the need to curve a film that will tend to revert towards being flat.

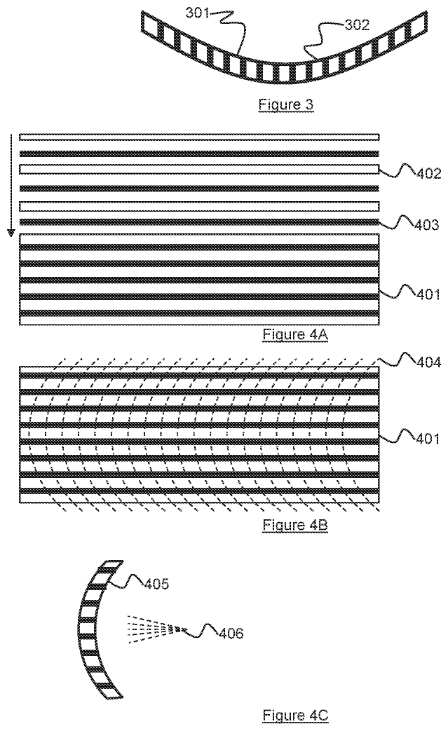

Instead, it is proposed herein to provide a privacy film as shown in FIG. 3, with parallel opaque elements 301 and transparent elements 302 between them, and which has a curved cross section when no force is applied. This can either be applied to a display screen with the same curve, to provide a consistent viewing angle, or to a display screen having a smaller radius of curvature, to improve viewing closer to the display screen.

In order to aid in the description of the curved privacy film, an exemplary method of manufacture will now be described. However, it should be appreciated that the curved privacy film may be manufactured by other means. The method described provides one possible means of manufacture, which allows for a large number of such privacy films to be manufactured simultaneously.

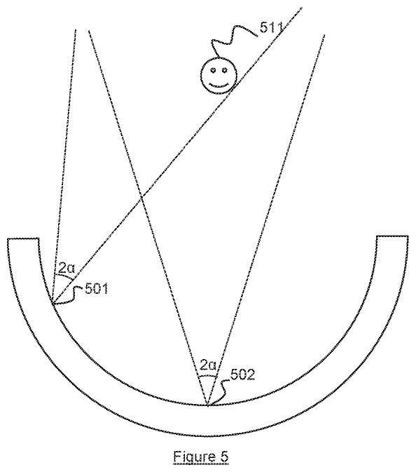

The manufacturing method is illustrated in FIGS. 4A through 4C. In general, the method of manufacture comprises three steps:
1. Providing a block comprising alternating transparent layers and opaque layers, where the layers are flat (FIG. 4A)
2. Cutting the block to form a film (or a plurality of films) having a curved cross section when no force is applied, with each of the layers of step 1 extending across the film (FIG. 4B)
3. Polishing the cut surface of the film, or applying a transparent coating to the cut surface (FIG. 4C)

Each of these steps will be described in more detail below.

Step 1, providing the block, can be achieved by any suitable means of providing a block with a stack of flat layers that alternate between transparent layers and opaque layers. For example, as shown in FIG. 4A the block 401 may be constructed by stacking together transparent layers 402 (made from a suitable transparent material) and opaque layers 403 (made from a suitable opaque material), and bonding them by adhesive, heat bonding, or similar. As a further example, transparent layers made from a suitable transparent material may be stacked and bonded together using an opaque adhesive, with the adhesive forming the opaque layers. Either of the previous examples may be done in a reel-to-reel process, as known in the art—i.e. with each of the non-adhesive layers being provided as a film on a reel, and those films pulled through to other reels via components which apply adhesive and bring them together with the other layers. As a yet further example, one or both of the transparent and opaque layers may be applied as a liquid (e.g. a resin, or a material above its melting point), formed into the layer, and allowed to solidify (e.g. cure or set) before the next layer is stacked on top. Optionally, there may be a polishing step after a liquid layer is allowed to solidify, to ensure that the upper surface of the layer is smooth and flat. As a yet further example, the block may made by an extrusion process.

The block may be provided with a depth perpendicular to the layers which is equal to the width of the intended final privacy film (measured across the curved cross section), and a width which is equal to the height of the final privacy film (measured perpendicular to the width of the privacy film, when viewed straight on). One way to achieve this is to manufacture a larger block (e.g. 1 meter width), and cut the large block to the required width.

The transparent layers may be made from any suitable transparent material, e.g. acrylic,
polycarbonate, polyethylene terephthalate (PET), or a resin such as epoxy resin.

The opaque layers may be made from any suitably opaque material, or from a transparent material with an additional pigment. Where the opaque layers comprise an opaque adhesive, this opaque adhesive may comprise an adhesive and a pigment.

In step 2, the block provided in step 1 is cut to form a film (or a plurality of films) having a curved cross section. This may be achieved by making a curved slice 404 through the block, across all the layers, as shown in FIG. 4B, to produce a film curved around one axis. This may be achieved by wire cutting (i.e. cutting using a wire moving at high speed, and moving the block relative to the wire or vice-versa along a curve to achieve the required cut). Several films may be cut in a single step, e.g. by a multi-wire cutting process where several parallel wires are used (or one wire which loops back and forth to provide several parallel cutting surfaces).

In step 3, the cut surface of the privacy film 405 is polished or coated to ensure that it is smooth, at least for the transparent sections. This is because the cutting method will generally not leave a smooth surface which would allow light to pass through the privacy screen. The appropriate polishing method will depend on the material of the transparent layer, but may include any of vapour polishing 406 (FIG. 4C, e.g. for acrylic or polycarbonate), mechanical polishing (e.g. for PET), or laser polishing. Alternatively or additionally, a transparent coating such as a confocal polymer coating may be applied, to provide a smooth surface to the privacy film and fill in any roughness of the transparent sections of the film.

While FIGS. 3 and 4A to D show a film which has a consistent radius of curvature, this need not be the case—e.g. wire cutting would allow the film to be cut with any curved surface desired, provided that curved surface can be formed by the continuous movement of a straight line (i.e. it is a “ruled surface”), and more complex machining techniques would allow the formation of other curved surfaces.

The privacy film may be applied to a display screen with a matching curvature. Alternatively, the privacy film may be applied to a display screen with a lower radius of curvature (for a concave screen) or a greater radius of curvature (for a convex screen), as shown in FIG. 5—in this case, the viewing angles on the curved privacy film will be directed slightly inwards for the outer regions of the display screen (e.g from the point 501), while the viewing angle at the centre of the display screen 502 will still be symmetrical about a line perpendicular to the screen. This allows a viewer 511 to be closer to the display screen and still be within the viewing angle of all points, and further reduces the ability of viewers to the side of the screen to see the information on the display screen.

### LIST OF REFERENCE NUMERALS

101 transparent section
102 opaque section
200 curved display
201 centre of display
202 example point towards edge of display
211 first viewer
212 second viewer
301 opaque element
302 transparent element
401 block
402 transparent layer
403 opaque layer
404 curved slice
405 privacy film
406 vapor polishing
501 example point towards edge of display
502 centre of display
511 viewer

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

The figures are schematic only, and do not represent accurate dimensions. As an example, the privacy film may be 50 microns to 300 microns thick, e.g. 200 microns thick. The transparent layers of the block (and therefore the transparent elements of the privacy film) may be 50 to 200 microns thick, e.g. 100 microns thick. The opaque layers of the block (and therefore the opaque layers of the privacy film) may be 5 to 50 microns thick, e.g. 15 microns thick.

Although the disclosure has been described in terms of examples as set forth above, it should be understood that these examples are illustrative only and that the claims are not limited to those examples. Those skilled in the art will be able to make modifications and alternatives in view of the disclosure which are contemplated as failing within the scope of the appended claims. Each feature disclosed or illustrated in the present specification may be incorporated in any embodiments, whether alone or in any appropriate combination with any other feature disclosed or illustrated herein

1. A method of manufacturing a privacy film for a curved display screen, the method comprising:
providing a block comprising alternating transparent layers and opaque layers, wherein the transparent layers and opaque layers are flat;
cutting the block to form a film having a curved cross section when no force is applied, with each of the transparent and opaque layers extending across the film; and
polishing the cut surfaces or applying a transparent coating to the cut surfaces.

2. A method according to claim 1, wherein cutting the block comprises wire cutting the block.

3. A method according to claim 1, wherein the transparent layers comprise one or more of:
acrylic;
polycarbonate;
polyethylene terephthalate, PET; and
a resin.

4. A method according to claim 1, wherein providing the block comprises gluing together a plurality of transparent layers using a mixture of an adhesive and a pigment, wherein the adhesive and pigment form the opaque layers.

5. A method according to claim 1, wherein providing the block comprises gluing together the transparent layers and the opaque layers.

6. A method according to claim 4, wherein the step of providing the block is done via a reel to reel process.

7. A method according to claim 1, wherein providing the block comprises:
a) pouring a first liquid to form a first flat layer;
b) curing or setting the first liquid to solidify the first flat layer;
c) pouring a second liquid to form a second flat layer overlaid on the first flat layer;
d) curing the second liquid to solidify the second flat layer;
repeating steps a) to d) to form further flat layers, each layer overlaid on a previous flat layer;
wherein:
one of the first or second liquid is:
a resin that cures to form a transparent solid; or
a material which is solid and transparent at room temperature, wherein step a) is performed above the melting point of the material;
and the other of the first or second liquid is:
a resin that cures to form an opaque solid; or
a material which is solid and opaque at room temperature, wherein step c) is performed above the melting point of the material.

8. A method according to claim 1, wherein providing the block comprises providing a large block, and cutting the large block to form a plurality of blocks.

9. A privacy film for a curved display screen, wherein:
the privacy film has a curved cross section when no force is applied; and
the privacy film comprises alternating transparent layers and opaque layers, each extending across the privacy film, and each parallel to the other transparent and opaque layers when no force is applied.

10. A privacy film according to claim 9, wherein the transparent layers comprise one or more of:
acrylic;
polycarbonate;
polyethylene terephthalate, PET; and
a resin.

11. A method of applying a privacy film according to claim 9 to a curved display screen, wherein the display screen has a curved cross section which has a radius of curvature which is less than a radius of curvature of the curved cross section of the privacy film, the method comprising bending the privacy film to reduce its radius of curvature during application of the privacy film.
